(19) United States
(12) Patent Application Publication
(10) Pub. No.: US 2023/0180677 A1
(43) Pub. Date: Jun. 15, 2023

(54) PLANT PROTECTION GUARDING SYSTEMS AND METHODS

(71) Applicant: BRAILSFORDS LIMITED, Christchurch (NZ)

(72) Inventor: Stephen Francis John BRAILSFORD, Christchurch (NZ)

(73) Assignee: BRAILSFORDS LIMITED, Christchurch (NZ)

(21) Appl. No.: 17/783,631

(22) PCT Filed: Dec. 9, 2020
(86) PCT No.: PCT/NZ2020/050170

§ 371 Date: Jun. 8, 2022

(30) Foreign Application Priority Data
Dec. 10, 2019 (NZ) 760016

(51) Int. Cl. A01G 13/02; A01G 5/02

(52) U.S. Cl. CPC A01G 13/0243; A01G 5/02

(57) ABSTRACT

A plant protection guarding system is described comprising an upper sleeve that is configured, in use, to be positioned around a plants stem and to extend upwards from ground level; and a lower portion comprising one or more anchor portions configured, in use, to extend around a root system of the plant to anchor the plant protection sleeve after planting. Further aspects are described to a prepared plant assembly; methods of forming a plant assembly; methods of planting a plant using a planting tool and a prepared plant assembly.

### RELATED APPLICATIONS

This application derives priority from New Zealand patent application number 760016 filed on 10 Dec. 2019, WIPO DAS Code E2AF, incorporated herein by reference.

### TECHNICAL FIELD

Described herein a systems and methods for the protection of plants and in particular plant protection guarding systems and methods.

### BACKGROUND ART

Plant guarding systems (also termed interchangeably hereafter using the trade marks or descriptions Plant Guard™, TriGuard™, TerraGuard™, EmGuard™, NaturaGuard™ spray guard, plant sleeves or CombiGuard™) may be used to protect young plants or seedlings after they are planted. The plant guarding systems aim to protect from one or more of: weed growth, herbicides, wild and domestic animal grazing, frost and desiccating wind. The plant guarding systems also may provide a more ameliorated growing environment for establishing seedlings and a means of identifying the crop plants from the non-crop growth at a planting site.

Existing plant protection/guarding systems are installed after the seedlings are planted in the ground. They are typically comprised of three defining components described below with reference to a prior art protection guard shown in FIG. 1:
(a) Generally, the plant guarding system enclosure is a three or four-sided structure that is often made of plastic, cardboard or coir. The seedling is surrounded by the open topped enclosure that extends from ground level up to various heights. Eventually, the enclosure can be removed once the plant is established.
(b) Stakes and pegs. Pegs are installed into the ground to support and hold the enclosure and mat in place. 1, 2, 3 or 4 pegs are required for the different products. Pegs are typically wood and bamboo and provide the rigidity and hold the guard in place after planting.
(c) Weed suppression mat is installed over the soil/ground surface in the immediate vicinity of the seedlings to cover a footprint larger than the enclosure. The mats function is to supress weed growth from within the enclosure and provide moisture retention. The mat is typically made of wool, coir, natural and manmade fibre.

Guarding systems such as that shown in FIG. 1 require three component parts (weed suppression mat, enclosure/sleeve and stakes). Installation is time-consuming and, especially on large planting projects, use of these guarding systems adds significant labour and materials expenses. Further, the sleeves can deteriorate and/or blow free of the plant over time, which means they are no longer protecting the plant and also creates a litter problem.

Cardboard and coir sleeves also tend to block light from getting through to the plant, which may limit growth. Holes in the sleeves, for example to allow installation of the stakes or to add a logo, encourages plant growth through the cut hole as opposed to encouraging plant growth upwards. Holes may also allow ingress of herbicide during spraying.

It may be desirable to provide improvements in plant guarding systems and methods or at least to provide the public with a useful choice.

Further aspects and advantages of the plant guarding systems and methods will become apparent from the ensuing description that is given by way of example only.

### SUMMARY

Described herein are plant protection guarding systems and methods to provide plant protection. The guard structure supports the plant's root system after pre-assembly up to the time of planting. The guard and its anchoring portion may be formed from a single piece of material and once planted there may be no need for any weed mat, pegs or stakes.

In a first aspect, there is provided a plant protection guarding system comprising:
an upper sleeve that is configured, in use, to be positioned around a plant's stem and to extend upwards from ground level; and
a lower portion comprising one or more anchor portions configured, in use, to extend around a root system of the plant to anchor the plant protection sleeve after planting.

In a second aspect, there is provided a plant protection guarding system comprising:
an upper sleeve that is configured, in use, to be positioned around a plant's stem and to extend upwards from ground level; and
a lower portion comprising one or more anchor portions configured, in use, to anchor the plant protection sleeve after planting;
wherein the upper sleeve and the lower portion are formed from a single piece of material.

In a third aspect, there is provided a plant protection guarding system, comprising:
an upper sleeve that is configured, in use, to be positioned around a plant's stem and to extend upwards from ground level; and
a band arranged to be positioned, in use, around a lower part of the upper sleeve and the plant's stem.

In a fourth aspect, there is provided a prepared plant assembly, comprising a plant assembled with a plant protection guarding system substantially as described above.

In a fifth aspect, there is provided a method of forming a plant assembly, comprising introducing a plant into a plant protection guarding system substantially as described above.

In a sixth aspect, there is provided a method of forming a plant assembly, comprising introducing a plant into a plant protection guarding system substantially as described above and securing the band around the plant's stem.

In a seventh aspect, there is provided a method of planting a plant using a planting tool that comprises a hole-forming arrangement and a planting tube, the method comprising:
forming a hole using the hole-forming arrangement; and
releasing a prepared plant assembly substantially as described above via the planting tube into the formed hole.

The systems and methods may have the advantage of reduced labour and material costs compared to art guard systems and methods, and may have the convenience of pre-assembly of the plant and plant guard before planting.

### BRIEF DESCRIPTION OF THE DRAWINGS

Further aspects of the plant guarding systems and methods will become apparent from the following description that is given by way of example only and with reference to the accompanying drawings in which:

FIG. 1 shows a prior art plant protection sleeve;

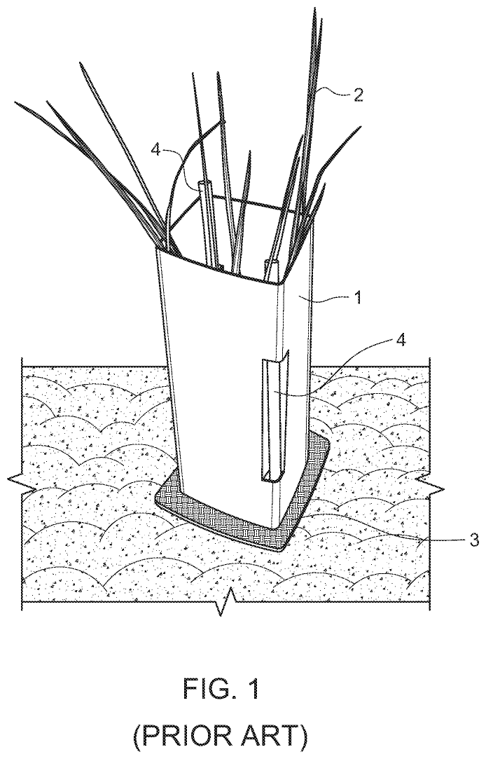

FIG. 2 shows a plant protection sleeve according to one embodiment;

FIG. 3 shows an assembly tool and plant, before assembly with a plant protection sleeve;

FIG. 3A shows a plant protection assembly positioned on the assembly tool of FIG. 3, before assembly with a plant;

FIG. 4 shows a plant and plant protection sleeve, with the tool of FIG. 3;

FIG. 5 shows the assembled plant and plant protection sleeve, with a tool for fitting of an elastic band;

FIG. 6 shows an assembled plant and plant protection sleeve, planted in the ground;

FIG. 7 is a further view of the plant and plant protection sleeve of FIG. 6;

FIG. 8 is a more detailed view of the sleeve's anchor portion and the plant's root system;

FIG. 9 is another detailed view of the sleeve's anchor portion and the plant's root system;

FIG. 10 shows a planting tool in a first position;

FIG. 11 shows the planting tool of FIG. 10, in a second position;

FIG. 12 shows a view from above of a plant and plant protection sleeve;

FIG. 13 shows the plant protection sleeve of FIG. 2 unfolded in a perspective view from below; and

FIG. 14 shows a detail perspective view from below of the plant protection sleeve of FIG. 2 unfolded.

### DETAILED DESCRIPTION

As noted above, the Applicant's plant protection guarding systems and methods provide plant protection with reduced labour and material costs, and the convenience of pre-assembly of the plant and plant guard before planting. The guard structure supports the plant's root system after pre-assembly up to the time of planting. The guard and its anchoring portion may be formed from a single piece of material and once planted there may be no need for any weed mat, pegs or stakes.

The structure of the sleeve provides the protective function and also anchors the sleeve to the plant and/or to the ground/site of planting. While formed from a relatively cheap and lightweight material, the structure of the sleeve may provide added rigidity (i.e. rigidity greater than the plain sheet material) which may assist in keeping the sleeve upright. Further, the structure of the sleeve allows a smaller structure with less wind resistance early in the plant's life, while accommodating plant growth over time. Use of suitable tools may improve efficiency in assembly of the plant and plant protection sleeve, and the planting operation.

For the purposes of this specification, the term ‘about’ or ‘approximately’ and grammatical variations thereof mean a quantity, level, degree, value, number, frequency, percentage, dimension, size, amount, weight or length that varies by as much as 30, 25, 20, 15, 10, 9, 8, 7, 6, 5, 4, 3, 2, or 1% to a reference quantity, level, degree, value, number, frequency, percentage, dimension, size, amount, weight or length.

The term ‘substantially’ or grammatical variations thereof refers to at least about 50%, for example 75%, 85%, 95% or 98%.

The term ‘comprise’ and grammatical variations thereof shall have an inclusive meaning—i.e. that it will be taken to mean an inclusion of not only the listed components it directly references, but also other non-specified components or elements.

Guarding System with an Upper Sleeve and a Lower Portion

In a first aspect, there is provided a plant protection guarding system comprising:
an upper sleeve that is configured, in use, to be positioned around a plant's stem and to extend upwards from ground level; and
a lower portion comprising one or more anchor portions configured, in use, to extend around a root system of the plant to anchor the plant protection sleeve after planting.

### Upper Sleeve

The upper sleeve may enclose the sides of a plant with an opening at the top of the upper sleeve for a plant to grow from.

A base or lower end portion of the upper sleeve may abut the ground about the plant stem, in some embodiments slightly in the ground, on the ground or slightly above the ground. No special positioning of the base of the upper sleeve is needed relative to the ground and the exact position relative to the ground surface is not critical but is ideally close to or on the ground surface to discourage weed growth inside the upper sleeve.

The height of the upper sleeve may be varied to suit the plant used in the guarding system. For example very small seedlings may have a shorter height upper sleeve than a larger more established seedling. Plants that grow to larger sizes may have a taller upper sleeve than plants that grow to lower heights and so on.

The upper sleeve may have continuous sides. That is, the sides of the upper sleeve may have no substantial openings, slits or holes. In an alternative embodiment, the upper sleeve sides may comprise openings, slits or holes, however, the openings, slits or holes comprise no more than 5, or 4, or 3, or 2, or 1% of the total surface area of the side(s) of the upper sleeve.

The top of the upper sleeve furthest from the ground may comprise a continuous opening. That is, the top of the upper sleeve has no restrictions and is open to the environment. In an alternative embodiment, the top of the upper sleeve may comprise an arm or arms linking sides of the opening to each other. In this embodiment, the arm(s) may be relatively thin so as to minimise blocking light or moisture to a plant inside the guarding system.

The cross-section width of the upper sleeve at a widest point when a plant is initially planted inside the guarding system may be approximately 1-30, or 1-20, or 1-10, or 2-6, or 3-5 times the above ground portion of the plant width when the plant is initially planted. For example, if a plant seedling when planted with the guarding system has an above ground maximum width of approximately 20 mm, the upper sleeve may have a maximum cross-section width of approximately 20 to 600 mm, or 20-400 mm, or 20-200 m, or 40-120 mm, or 60-100 mm. As may be appreciated, the maximum cross-section width of the upper sleeve may be variable in position as the upper sleeve may not be symmetrical and/or circular.

The height of the upper sleeve above the ground at a highest point when a plant is initially planted inside the guarding system may be approximately 1-6, or 2-6, or 3-6, or 2-5, or 2-4 times the height of the above ground portion of the plant when the plant is initially planted. For example, if the plant when planted extends approximately 50 mm above the ground surface, the upper sleeve may extend 50-300 mm, or 100-300 mm, or 150-300 mm, or 100-250 mm, or 100-200 mm above the ground surface. The maximum height of the upper sleeve may be variable however it is anticipated that for most applications, the upper sleeve will have a common maximum height about an upper end of the upper sleeve.

The upper sleeve may be configured to provide protection to the above ground portion of a plant inside the upper sleeve for a period of time until the plant has grown and is established at the planting site. The upper sleeve has the function of providing a sheltered and warmer environment inside the sleeve to support plant growth which may be useful at transplanting and/or early stages of plant growth.

### Lower Portion

The lower portion of the system may provide an anchor to the upper sleeve.

The lower portion as noted comprises anchors that engage with the plant roots/root ball to prevent the guard and plant from becoming separated e.g. due to wind. Engagement may be through use of extending portions from the upper sleeve that link with the plant roots or root ball. Legs as anchors are described further below however other shaped anchor methods may be used e.g. pointed extensions that grip the roots/root ball and/or anchors of sufficient length to extend under the roots/root ball and be anchored by the plant weight. The term ‘anchor’ as used herein refers to a means for holding the lower portion of the guarding system into the ground.

The lower portion is termed ‘lower’ to refer to the fact that this portion/portions in use are situated beneath the ground surface. This effectively anchors the upper sleeve in place relative to the ground and plant stem/roots and prevents or at least slows the timing of when the guard may be removed from or detaches from the plant.

The lower portion of the guarding system described may be linked to the upper sleeve. Many art guard systems instead rely on separate pegs or stakes to anchor an upper sleeve in place, these pegs or sleeves requiring extra labour to install and which are more prone to release from the plant since they are not integral to or around the plant roots/root ball.

In one embodiment, the lower portion of the guarding system defines a volume below the ground. This volume is defined partly by the shape of a plant root system or root ball and partly by the shape of the lower portion that extends about the plant roots/root ball. This volume may be of varying shape e.g. cylindrical, ovoid, prism shaped, cuboid and so on. The shape may be substantially defined by the shape of the root ball which in turn is typically governed by the shape of the container in which the plant was growing.

The volume of the lower portion is characterised by having large openings so that the majority (greater than 50, or 60, or 70, or 80, or 90% by surface area) of the plant roots/root ball when planted in the guarding system directly bear on the surrounding ground in which the plant is planted. Expressed another way, the lower portion may comprise anchors and the anchors are relatively thin compared to the overall surface area of the plant roots/root ball. The anchors in this embodiment are sized to be sufficiently larger to provide a structural link to the upper sleeve but minimised in size to allow as much contact as possible between the plant roots/root ball and the surrounding ground in which the plant is planted. An intention of the use of large openings like this is to allow for the plant to grow beyond the lower portion volume and into the surround environment plus also to allow for free movement of water, plant nutrients and so to and form the plant and surrounding environment.

The lower portion width may be the same as the upper sleeve maximum cross-section width. Instead, the lower portion width may taper at least somewhat relative to the upper sleeve maximum cross-section width, tapering reaching a minimum width about the lower portion base, the lower portion base being about the base of the plant roots/root ball.

The lower portion depth below ground when used with a plant may, at a greatest depth when a plant is initially planted inside the guarding system may be approximately 1-4, or 1-3, or 1-2, times the depth of the plant root system/root ball when the plant is initially planted. For example, if the plant root ball when planted has a depth of approximately 30 mm below the ground surface, the lower portion volume extends 30-120 mm, or 30-90 mm, or 30-60 mm below the ground surface. The maximum depth of the lower portion may be variable however it is anticipated that for most applications, the lower portion will have a common maximum depth about the base of the plant roots/root ball. In one embodiment, the lower portion volume is substantially the same as the volume prescribed by the plant roots/root ball when the plant is planted.

### Folded/Open Configurations

The guarding system described may comprise a substantially flat configuration when not used i.e. at manufacture or storage; and an open or unfolded configuration when used.

In a flat configuration, the guarding system folds together in the inventors experience to a very small shape. The exact thickness of the guarding system when folded may vary depending on the wall thickness of the guarding system parts however a thickness of less than 2 or even 1 mm is achieve based on the inventors experience. As may be appreciated, this small thickness means it is easy to transport and store the above described guarding system prior to use.

Opening of the folded guarding system may be completed by hand or using a tool such as the tools described later in this specification. Insertion of the plant itself will also cause unfolding of the guarding system.

Once unfolded, the guarding system as a whole may define a volume which as noted above comprises an upper sleeve and lower portion, the two parts having an unfolded volume that may have a prism, cylinder, ovoid or cuboid shape. In one example, guarding system volume in an unfolded configuration defines a rectangular prism in at least the upper sleeve of the guarding system. In this example of a prism shaped upper sleeve volume, corners of the prism shape may be defined by pleats or folds described further below. The prism corners of the upper sleeve of the unfolded guarding system may, in one embodiment, be coincident with pleats or folds in the upper sleeve. The pleats or folds noted may extend along a portion or portions of the lower portion e.g. along one or more anchors or legs as described further below.

### Pleats

The upper sleeve may comprise one or more substantially vertical pleats. The one or more substantially vertical pleats may comprise a pair of opposing pleats, positioned on opposite sides of the upper sleeve.

Pleats have been found by the inventor to assist with providing rigidity to the upper sleeve yet allowing for folding of the guard when manufactured, transported or being stored. The pleats extend when the guard is unfolded but remain partly folded when in use and this helps the upper sleeve remaining standing post installation in the ground. Pleats also can expand as the plant grows hence initially provides a snug smaller environment for the small seedling and, as the seedling grows, the pleats open to allow room for the plant to expand within the guard.

### Weaknesses

The upper sleeve may comprise one or more weaknesses. The one or more weaknesses may comprise a plurality of perforations formed in the upper sleeve. At least some of the one or more weaknesses may extend upwards along the upper sleeve.

The term ‘weaknesses’ as used herein refer to a part or parts of the guard that may be deliberately stressed or weakened or made frangible. The function of a weakness as described herein is to allow a plant room to grow beyond the volume described by the guard. For example, the weakness may be a perforation in the upper sleeve that splits open when a plant grows to a point that imposes a tensile force of predetermined strength across the perforations. Weaknesses may be perforations as noted or be achieved via other means e.g. a section of thinner material at the weakness, cuts or slots and so on.

The one or more weaknesses may extend generally upwards in a vertical plane along a side or sides of the upper sleeve. The exact direction may be somewhat offset to straight line upward and/or may be curved or of a tortuous path.

### Legs

The lower portion anchors as noted above may comprise a plurality of legs.

At least some of the plurality of legs may be connected to each other at a lower end of the anchor portion. In one embodiment, the plurality of legs may comprise four legs connected to each other at the lower end. In an alternative embodiment, the legs extend under the plant roots/root ball but remain unconnected. In a further embodiment, the legs extend about and/or under the plant roots/root ball and a linking feature or features act to grip onto the plant roots/root ball or soil to resist removal of the legs from the ground.

The term ‘legs’ as used herein refers to elongated extensions from the upper sleeve of the guard. The legs may be relatively small in width (30 mm or less) and have a thickness identical or similar to the thickness of the upper sleeve wall thickness.

The legs may extend from differing sides of the upper sleeve and connect together about the leg ends. If two legs are used, the legs may extend from opposing sides of the upper sleeve. If four legs are used, each leg may extend from a point equidistant to the other legs. Legs may extend from a mid-point between corners of an upper sleeve. Legs may alternatively extend from an apex of an upper sleeve corner. One or more legs may extend coincident with a pleat if used in the upper sleeve. In this embodiment, the pleat may continue along the leg or a portion thereof.

Connection of the legs may occur at the leg endings distal to the upper sleeve. Connection of the legs endings together may be achieved using heat e.g. via welding; via mechanical means e.g. via a staple; or via chemical means e.g. using an adhesive. All leg endings may be connected so as to form a volume therein suitable to hold a plant seedling root ball.

As noted above, the one or more legs extend under the plant roots/root ball and in doing so, provide an anchor to the guard to prevent the guard from removal about the plant.

### Open Anchor Portion

The anchor portion may be at least partly open allowing fluid flow and root growth after planting.

The anchor portion (or legs using the above embodiment) may have sufficient spacing therebetween to allow flow of water, nutrients plant roots or other materials between a root ball held within the anchor portions and the surrounding ground in which the plant is planted. The openings allow the plant to establish itself in the planted environment yet also allows the anchor portions and guard to remain firmly attached to the ground about the plant.

### Material Used

The plant protection guarding system may in one embodiment be formed from plastic. The plastic may have a thickness of approximately 50 to 350, or 75 to 325, or 100 to 300, or 125 to 275, or 100 to 250, or 100 to 200, or 100 to 150 microns. The plastic may be a low density polyethylene.

Alternatively, the plant protection sleeve may be formed from a biodegradable material arranged to break down over a required lifetime of the sleeve after planting. This biodegradable material may have a similar material thickness as the plastic noted above or varied to suit the desired longevity of the material and the desired material stiffness.

Plastic remains a useful material to use for guard systems despite environmental drawbacks as it provides a compromise between material stiffness, ease of working, cost efficiency and light transfer to the plant inside the guard. Art biodegradable materials may not provide the same characteristics of stiffness, ease of manufacture, cost efficiency and light transfer e.g. card board tends to degrade rapidly in wet environments, sometimes faster than desired relative to plant growth and the level of light transfer to the seedling may be quite poor. Plastics used to form the guard systems may also be readily recyclable hence allow at least some degree of reuse of the materials. That said, biopolymers and biodegradable materials are rapidly developing and new compostable materials or organic plastics like PLA may offer alternative materials to use in the described guard systems. Reference to plastic should therefore not be seen as limiting.

### Single Material

The upper sleeve and the lower portion may be formed from a single piece of material.

As described, in the art, guard systems are typically manufactured from an above ground portion such as a sleeve or box shape structure and then this is held in place using separate pegs to hold the guard in place. The guard system described may be manufactured from one continuous piece of material with no breaks or alternative parts used for the above ground upper sleeve portion of the below ground anchor portion(s). This leads to lower manufacturing costs, fewer parts and materials needed, lower complexity and faster installation. Removing the need for pegs also reduces the risk of guard systems detaching from the plant prematurely—pegs and separate sleeves can detach in high winds or quicker than desired through material deterioration.

### Band

The plant protection guarding system may further comprise a band arranged to be positioned, in use, around a lower part of the upper sleeve and the plant's stem. The band may be positioned, in use, at a point immediately above the root ball of the plant. The band may be elastic.

A band or bands may be used as noted about a plant step. In one embodiment, the band or bands crimp together the base of the upper sleeve so as to reduce the diameter of the upper sleeve about the plant stem, typically about the ground surface. This has the advantage of reducing the potential for weeds or other plants to also grow inside the guard system and ultimately compete for growth with the target plant. Avoiding growth of weeds and the like within the guard system also minimises the need to periodically visit a new planting site and remove weeds. With art guard systems, periodic visits to a newly planted site are often required by planter staff to manually remove weeds growing within the guard system sleeves. This occurs due to the wider neck and sleeve opening of art guard systems. It is envisaged that it may be possible to remove the need for periodic visits and weeding post planting using the described guard system or to at least reduce the frequency of when follow up visits are required. This has a major impact on labour and hence costs of planting.

Guard System with Upper and Lower Portions from One Material

In a second aspect, there is provided a plant protection guarding system comprising:
an upper sleeve that is configured, in use, to be positioned around a plant's stem and to extend upwards from ground level; and
a lower portion comprising one or more anchor portions configured, in use, to anchor the plant protection sleeve after planting;
wherein the upper sleeve and the lower portion are formed from a single piece of material.

In the above aspect, a similar guard system is described however in this aspect, the upper sleeve and lower portion are manufactured from the one single piece of material. As noted above, this has a number of advantages for manufacture and structural integrity of the guard system.

Guard System with a Band

In a third aspect, there is provided a plant protection guarding system, comprising:
an upper sleeve that is configured, in use, to be positioned around a plant's stem and to extend upwards from ground level; and
a band arranged to be positioned, in use, around a lower part of the upper sleeve and the plant's stem.

As noted above, the use of a band may be a useful advantage of the guard system described herein, even where lower anchor portions are not used.

### Prepared Plant Assembly

In a fourth aspect, there is provided a prepared plant assembly, comprising a plant assembled with a plant protection guarding system substantially as described above.

Plants and the guard system described may be prepared before planting. This offers the advantage of faster planting once on a work site and hence less disruption and more efficient use of time at a work site. Often mass planting of land may occur in diverse country well away from cities or towns and hence, minimising worker time on site may be useful to reduce labour costs.

### Method of Forming a Plant Assembly

In a fifth aspect, there is provided a method of forming a plant assembly, comprising introducing a plant into a plant protection guarding system substantially as described above.

In a sixth aspect, there is provided a method of forming a plant assembly, comprising introducing a plant into a plant protection guarding system substantially as described above and securing the band around the plant's stem.

### Method of Planting a Plant

In a seventh aspect, there is provided a method of planting a plant using a planting tool that comprises a hole-forming arrangement and a planting tube, the method comprising:
a. forming a hole using the hole-forming arrangement; and
b. releasing a prepared plant assembly substantially as described above via the planting tube into the formed hole.

In the above aspects, simple tools are described that may allow for easy preparation and planting of plants using the guard system described. This may minimise labour needed and hence may lower planting cost and may minimise health and safety risks to planters.

The embodiments described above may also be said broadly to consist in the parts, elements and features referred to or indicated in the specification of the application, individually or collectively, and any or all combinations of any two or more said parts, elements or features.

Further, where specific integers are mentioned herein which have known equivalents in the art to which the embodiments relate, such known equivalents are deemed to be incorporated herein as if individually set forth.

### EXAMPLES

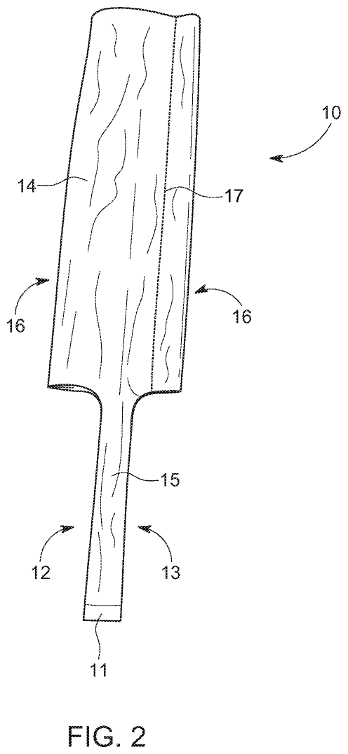

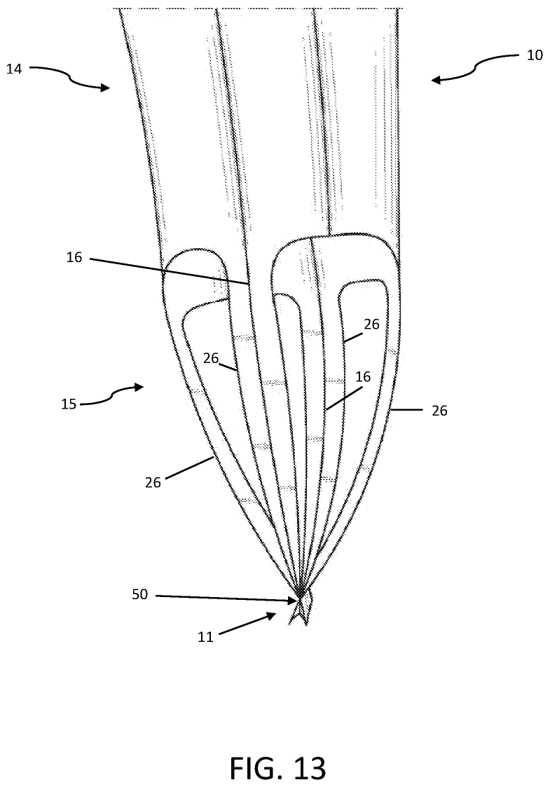

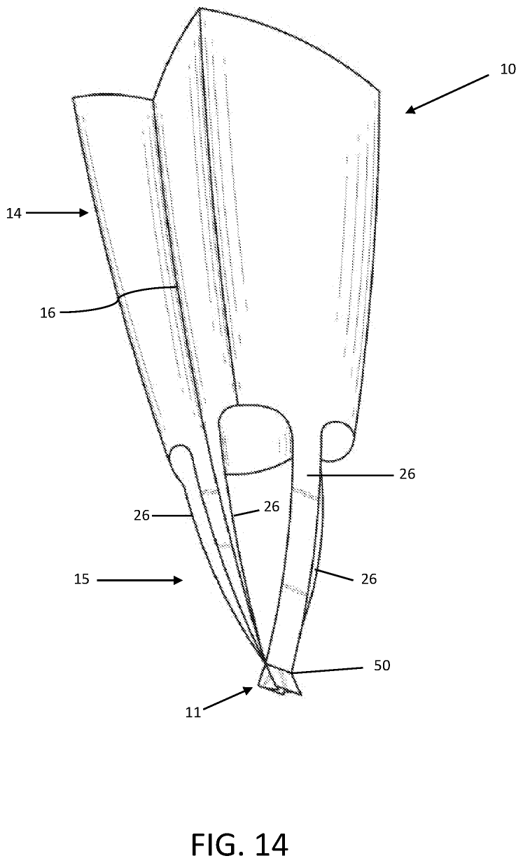

One embodiment of the Applicant's plant protection sleeve 10 is shown in a folded form, i.e. before assembly with a plant, in FIG. 2. FIG. 13 and FIG. 14 also shows more detail of the lower portion 15 of the sleeve 10 in an unfolded form.

The sleeve 10 may be formed as a single piece, for example from a single piece of plastic sheet or film using known plastics manufacturing techniques. In the embodiment shown the plant protection sleeve 10 may be formed in a similar manner to a plastic bag, with a generally tubular form that is sealed at one end 11, before cutting away of two lower regions 12, 13. This results in an upper sleeve portion 14 of the sleeve 10 extending upwards from a lower anchor portion 15. The upper sleeve portion 14 may have one or more pleats 16 extending upwards along its length, as will become clear below.

The upper sleeve portion 14 may also have one or more weaknesses 17, which may also extend upwards along its length. Each weakness 17 may comprise a series of perforations, holes, small cuts or other weaknesses 17 sufficient to tear or fail when pressure from the growing plant stem, branches and foliage acts outwards against the sleeve 10. These will also be discussed further below.

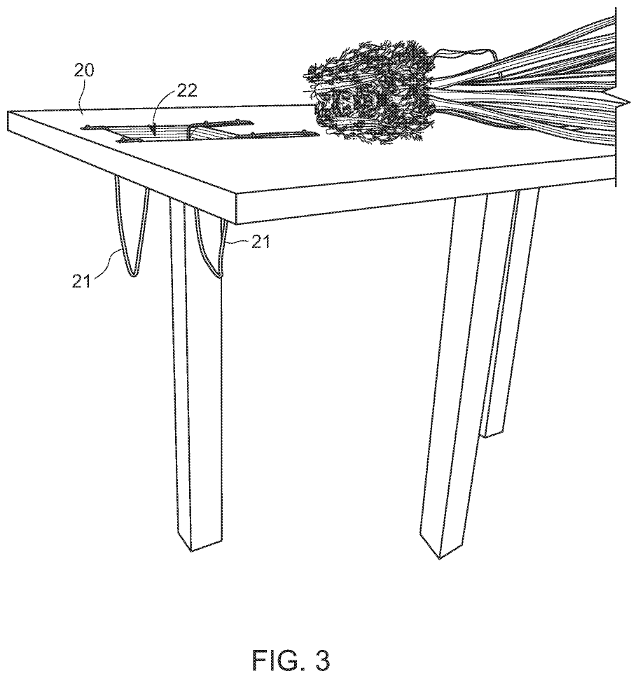

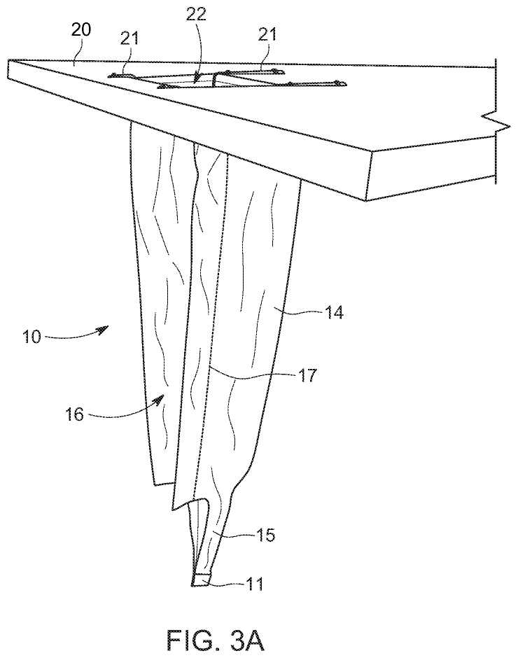

FIG. 3 shows an assembly tool, comprising a frame 20 and a pair of clips or spreaders 21 suitable to hold an upper edge of the upper sleeve portion 14 in an open position. FIG. 3A shows the plant protection sleeve 10 ready for introduction of a plant (e.g. a seedling). The frame 20 may have an opening 22 into which the plant may be inserted. FIG. 3A also shows one of the pleats 16 partially opening as the sleeve 10 expands.

The tool shown in FIGS. 3 and 3A may be adapted for partial or full automation.

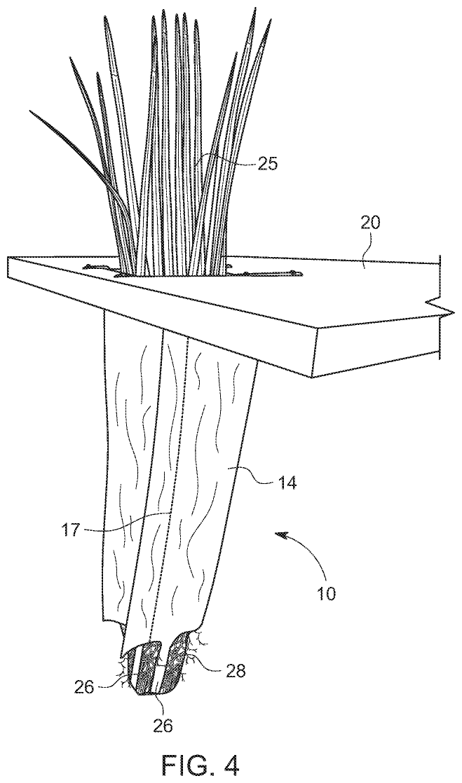

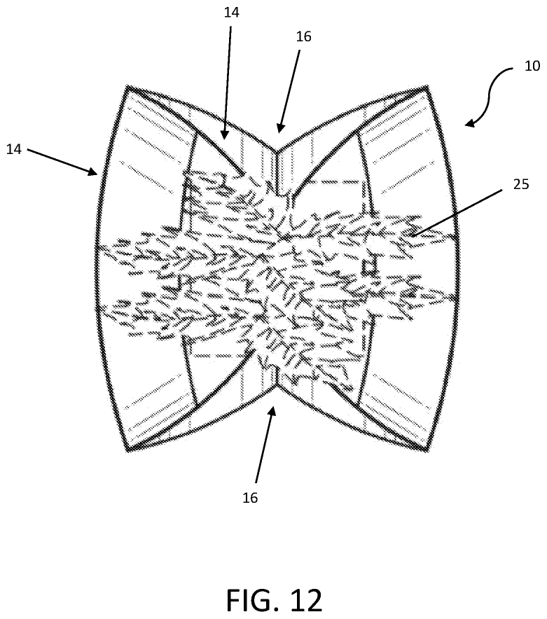

FIG. 4 shows the sleeve 10 and a plant 25 inserted into the sleeve 10. FIG. 12 shows a view from above with a plant 25 inserted into the sleeve 10. The plant's 25 root system (or root ball) 28 will slide down through the sleeve 10 and come to rest against the sealed lower end 11 of the sleeve 10. Thus, as best seen in FIGS. 4, 13 and 14, the anchor portion 15 may generally comprise a number of legs 26 that extend downwards from the upper sleeve portion 14 and are connected to each other at the lower end. This may be achieved e.g. by a conventional heat seal or weld 50 between the legs 26. The legs 26 therefore extend around the root system 28. After assembly of the plant 25 and plant protection sleeve 10, the anchor portion 15 may support the root ball/root system 28 of the plant 25. The anchor portion 15, once the assembled plant 25 and plant protection sleeve 10 are planted in the ground, acts to anchor the sleeve 10 both to the plant 25 and to the ground or site of planting. This can be contrasted with prior art sleeves that tend to be attached to the ground by pegs or stakes and can come free over time.

Note also that other configurations of anchor portion 15 may be possible and any suitable configuration may be used that acts to anchor the sleeve 10 to the plant 25 and ground after planting. This can comprise a mesh format in one example.

The anchor portion 15 is partly open, as can be seen in FIGS. 4 to 9 and 13 to 14. This allows the flow of fluids, comprising water and nutrients (not shown), through to the roots and also allows growth of the roots from the root ball 28 beyond the protection sleeve 10.

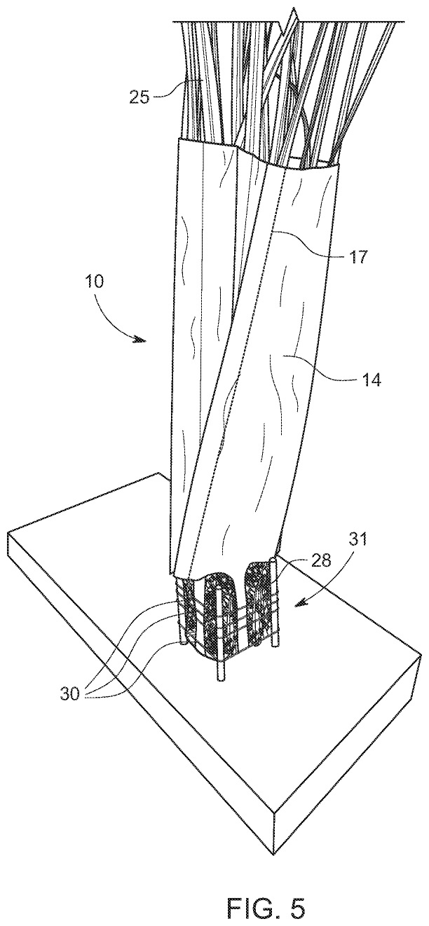

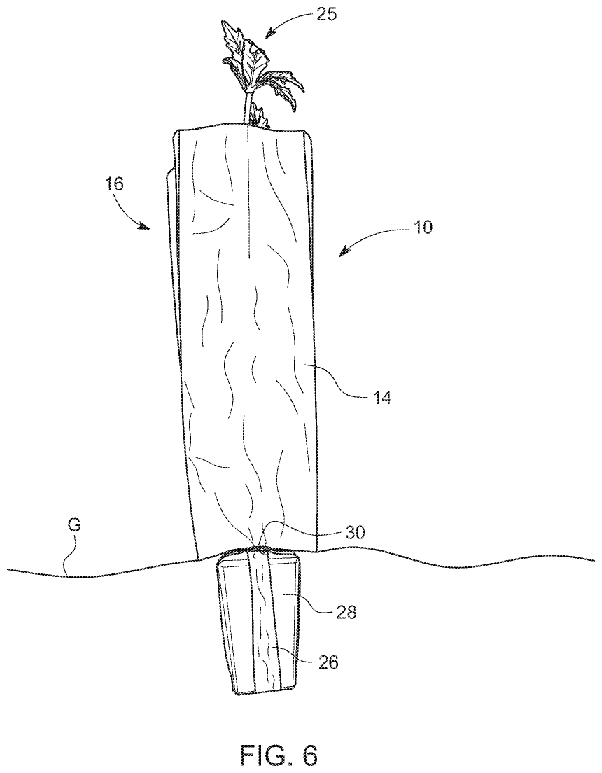

FIG. 5 shows a further tool arranged to facilitate the attachment of an elastic band to the assembled plant 25 and protection sleeve 10. This tool may comprise a support structure 31 on which a number of elastic bands 30 may be held in an extended state. The plant's 25 root system 28 and the anchor portion 15 may be passed down through the support structure 31, and one of the extended elastic bands 30 may then be released around a lower part of the upper sleeve portion 14 and the plant's 25 stem, as shown in FIG. 6. The band 30 once positioned may be located immediately above the root ball 28 of the plant 25. The released elastic band 30 effectively secures the anchor portion 15 and/or upper sleeve portion 14 around the top of the root system 28. Any suitable elastic bands 30 may be used, comprising widely available rubber bands 30. Other tying materials comprising jute string and the like may also be used instead of elastic bands 30. Unless otherwise stated, reference to a rubber band or elastic band should not be seen as limiting as other tying materials can be used.

Before planting, the rubber band 30 assists in keeping the plant 25 and sleeve 10 together, and also in supporting the plant's 25 root ball or root system 28 by keeping the anchor portion 15 tight around the plant 25 roots 28. Once the assembled plant 25 and sleeve 10 are planted in the ground, the elastic band 30 holds the sleeve 10 against the plant's 25 stem, limiting the opportunity for weed growth inside the sleeve 10. In many applications this may eliminate the need for a separate weed mat to be used. However, in some applications users may choose to add an optional weed mat around the outside of the sleeve 10.

The elastic band 30 may also constrict the base of the upper sleeve portion 14; bringing the pleats 16 into action and, when installed into the upper soil; provides a stronger base for the pleats 16; and improves rigidity of the upper sleeve portion 14. The pleats and/or folds 16 also increase the rigidity of the upper sleeve portion 14 when compared with a plain tube of the same material and therefore help to keep the upper sleeve portion 14 standing upright. This provides a functional upper sleeve portion 14 (capable of remaining substantially upright and withstanding wind loads) with a much lighter material than is used in prior art sleeves.

Optionally (and not shown), a peg or pegs (typically just one peg) may be fitted to aid initial rigidity while the plant 25 stem of the seedlings is not sufficient to provide the required support. A single peg may be used as short-term support. The peg may be inserted internally down the sleeve 10 and into the ground beside the root ball 28 of the plant 25 seedling as part of the planting process. This may hold the sleeve 10 rigid during extreme climatic events i.e. strong wind, driving rain and snowfall. Once the plant 25 seedling grows its stature takes over this rigidity function.

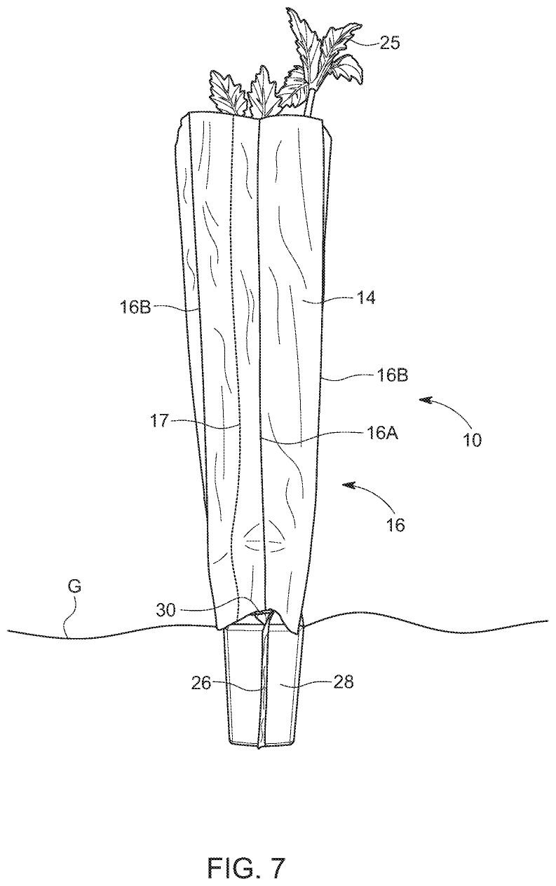

FIGS. 6 and 7 show views of assembled and planted plants 25 and sleeves 10, with the elastic band 30 in position. The root ball 28 and ground level G are shown schematically in these drawings. As shown in FIG. 7, each pleat 16 may be formed by an inner fold 16A and a pair of outer folds 16B. However, more complex or other configurations of pleat 16 using any suitable combination of folds 16 may be used.

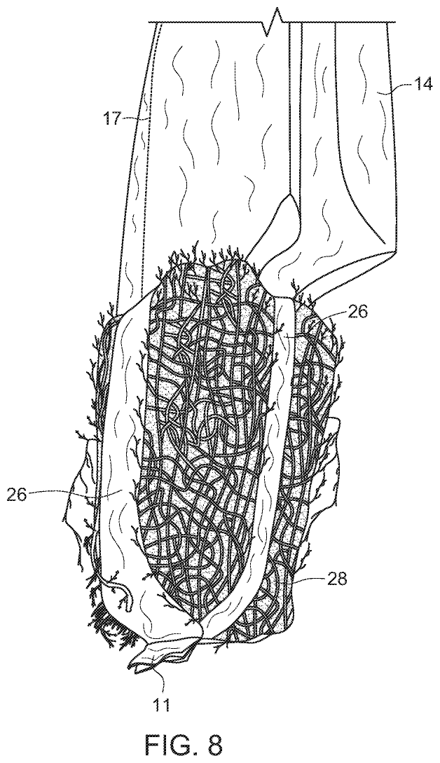

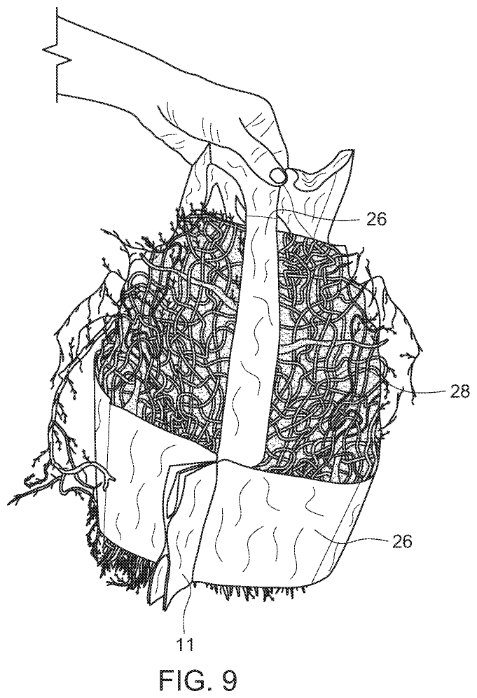

FIGS. 8 and 9 are further views showing the position of the anchor portion 15 around the root system 28.

The pleats and/or folds 16 provide some flexibility in the cross-sectional area of the upper sleeve portion 14. This means that the upper sleeve portion 14 can have a relatively small area early in the plant's 25 life (and therefore lower wind resistance), but the upper sleeve portion 14 can expand somewhat as the plant 25 grows. Once the plant 25 has grown sufficiently to force its stem or trunk outwards against the upper sleeve portion 14, the one or more weaknesses 17 will fail or tear, such that the upper sleeve portion 14 gives way and does not impede further plant 25 growth. The elastic band 30 will also stretch as the plant 25 grows, and the material and/or size of the elastic band/tie 30 may be chosen to fail after the plant 25 has grown to particular size, or to break down after a period of time.

The plant protection sleeves 10 may be assembled with plants 25 before the planting operation takes place. In one embodiment, the planting workers may be provided with pre-assembled plant assemblies comprising the plant 25 and protection sleeve 10. Assembly may occur in a facility at the nursery or at the planting site or elsewhere. This increases the efficiency of the operation, since assembly can occur as a separate operation with the correct assembly tools or jigs, and the planters or other workers do not need to perform any further steps after planting to position or secure the protection sleeve 10. This can be contrasted with prior art sleeves which required several steps after planting, comprising e.g. preparing and positioning a weed mat, positioning a protection sleeve and securing the sleeve and/or weed mat with pegs or stakes.

The Applicant's plant protection sleeve 10 may be formed by any suitable process. In one embodiment a plastic sleeve 10 may be produced, folded into square cross-sectional shape and at least one side (typically two opposing sides) may be folded and/or pleated 16. The bottom of the sleeve 10 may be sealed or welded 50, and the anchor portion 15 formed by suitable cutting operations.

Any suitable sleeve 10 material may be used. Plastic materials may be suitable, for ease of manufacture and low materials cost. Low density polyethylene may be used. The plastic material may have a thickness around 50 to 350, or 75 to 325, or 100 to 300, or 125 to 275, or 100 to 250, or 100 to 200, or 100 to 150 microns. In alternative embodiments, biodegradable and/or compostable materials and/or natural materials may be used (comprising e.g. biodegradable plastic materials etc). Such materials may be chosen to break down over the required lifetime of the sleeve 10.

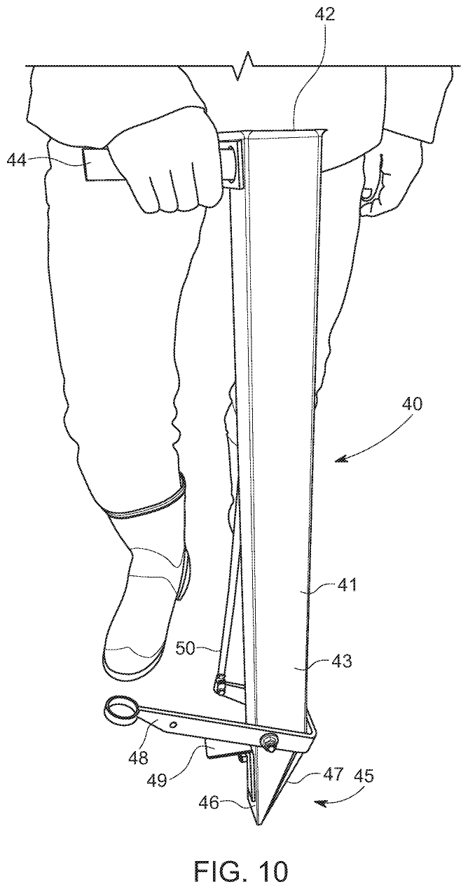

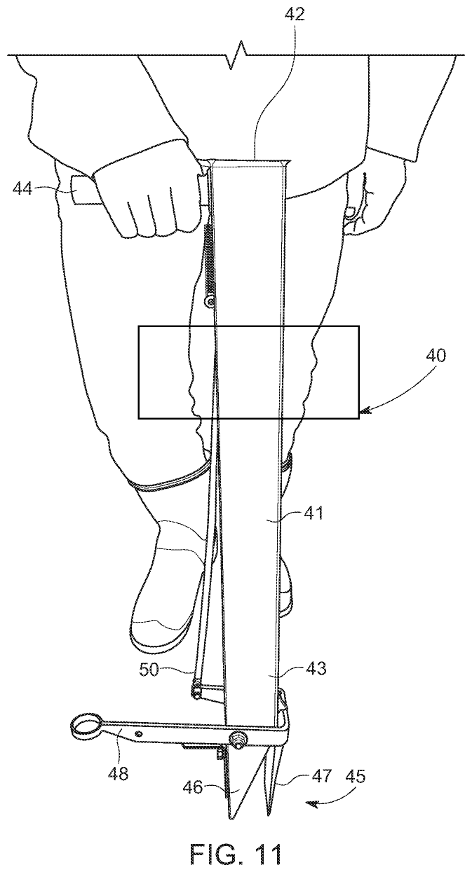

FIGS. 10 and 11 show a planting tool 40 configured for planting of the pre-assembled plants and plant protection sleeves 10. The tool 40 may comprise a tubular shaft 41 having an internal cross-section matching the shape of the plant assembly (i.e. the shape of the root system and sleeve 10). A plant assembly inserted at a top end 42 of the shaft 41 will therefore slide downwards to a lower end 43 of the shaft 41. The tool 40 may comprise one or more handles 44 assisting a user to hold and position the tool 40.

At a lower end of the tool 41 a hole forming arrangement 45 may be provided. In the embodiment shown this may comprise a pair of jaws 46, 47 configured to be moved between the closed position of FIG. 10 and the open position of FIG. 11. One of the jaws 46 may be a fixed jaw 46, while the other 47 can be actuated to move to the open position. In the embodiment shown, movement of the jaw 47 may be actuated by a foot-operated actuator or pedal 48. The tool 40 may also comprise a step or shoulder 49, on which a user can stand or stomp to help force the tool into the ground. A spring 50 may bias the jaw 47 to the closed position.

During a planting operation, a user may press the jaws 46, 47 down into the ground by applying pressure downwards on the handles 44 and/or the step or shoulder 49. The user may then step down on the pedal 48, which will cause the jaw 47 to open. The user may also rock or lever the tool 40 to assist in insertion into the ground and/or forming a hole. A plant assembly may be inserted into the open top end 42 of the shaft 41 before or after the hole is formed. With the jaws 46, 47 open, the plant assembly will drop down through the tool 40 into the newly-formed hole and the tool 40 may then be withdrawn. The user will then press the soil (usually with their foot) around the planted plant assembly to complete the planting operation. The planting operation is therefore completed efficiently and without requiring the user to bend down. Further, the assembled plant and plant protection sleeve 10 may be conveniently planted in a single operation, without the prior requirement for separate operations to secure the sleeve 10, weed mat, pegs, stakes etc.

The embodiments shown are for use with a plant having a generally square-shaped root ball. This shape is generally governed by the shape of the pot or other container in which the plant is raised. However, the skilled reader will understand that the sleeve 10 will accommodate various shapes of root ball. Further, the various tools discussed herein may be adapted for different shaped root balls.

Aspects of the plant guards systems and methods have been described by way of example only and it should be appreciated that modifications and additions may be made thereto without departing from the scope of the claims herein.

What is claimed is:

1-20. (canceled)

21. A plant protection guarding system comprising:
an upper sleeve that is configured, in use, to be positioned around a plant stem and which extends upwards from ground level; and
a lower portion comprising a plurality of anchor portions configured, in use, to extend around and connect together beneath a root system of the plant to anchor the upper sleeve to the ground;
wherein the upper sleeve and the lower portion are formed from a single piece of material; and
wherein the plant protection guarding system further comprises a band that, in use, crimps together the base of the upper sleeve so as to reduce the diameter of the upper sleeve about the plant stem.

22. The plant protection guarding system as claimed in claim 21 wherein the upper sleeve comprises one or more substantially vertical pleats and, wherein the one or more substantially vertical pleats comprise a pair of opposing pleats, positioned on opposite sides of the upper sleeve, the pleats being configured to provide rigidity to the upper sleeve yet allowing folding of the guard when manufactured, transported or stored.

23. The plant protection guarding system as claimed in claim 22, wherein the pleats are configured to extend when the guard is unfolded but remain partly folded when in use to allow the upper sleeve to remain standing post installation in the ground.

24. The plant protection guarding system as claimed in claim 22, wherein the pleats are configured to expand as the plant grows so that the guard initially provides a snug smaller environment for the plant and, as the plant grows, the pleats open to allow room for the plant to expand within the upper sleeve.

25. The plant protection guarding system as claimed in claim 22, wherein at least one of the anchor portions extend coincident with a pleat and the pleat extends from the upper sleeve along the anchor portion or a part thereof.

26. The plant protection guarding system as claimed in claim 21, wherein the upper sleeve comprises one or more weaknesses formed in the upper sleeve, the weaknesses configured to open when a plant grows to a point that imposes a tensile force of predetermined strength across the weakness or weaknesses, thereby allowing the plant room to grow beyond the volume described by the guard.

27. The plant protection guarding system as claimed in claim 21, wherein the lower portion is at least partly open allowing fluid flow and root growth after planting.

28. The plant protection guarding system as claimed in claim 21, wherein the band is positioned, in use, at a point immediately above the root ball of the plant.

29. The plant protection guarding system as claimed in claim 21, wherein the band is elastic.

30. The plant protection guarding system as claimed in claim 21, wherein the upper sleeve and lower portion are manufactured from plastic.

31. The plant protection guarding system as claimed in claim 21, wherein the upper sleeve and lower portion are manufactured from a material configured to fold and expand open.

32. The plant protection guarding system as claimed in claim 21, wherein the upper sleeve and lower portion material used has a thickness of 50-350 micron.

33. A prepared plant assembly, comprising:
a plant; and
a plant protection guarding system, the guarding system comprising an upper sleeve, a lower portion comprising a plurality of anchor portions, the upper sleeve and the lower portion being formed from a single piece of material and a band;
wherein:
the upper sleeve is positioned around a plant stem and extends around the above ground portion of the plant;
the lower portion anchor portions extend around and connect together beneath the plant root ball; and
the band crimps together the base of the upper sleeve so as to reduce the diameter of the upper sleeve about the plant stem.

34. A method of forming a plant assembly, comprising:
introducing a plant into a plant protection guarding system, wherein the plant protection guarding system comprises
an upper sleeve that is configured, in use, to be positioned around a plant stem and which extends upwards from ground level; and
a lower portion comprising a plurality of anchor portions configured, in use, to extend around and connect together beneath a root system of the plant to anchor the upper sleeve to the ground;
wherein the upper sleeve and the lower portion are formed from a single piece of material; and
wherein the plant protection guarding system further comprises a band that, in use, crimps together the base of the upper sleeve so as to reduce the diameter of the upper sleeve about the plant stem.

35. A method of planting a plant using a planting tool that comprises a hole-forming arrangement and a planting tube, the method comprising:
forming a hole using the hole-forming arrangement; and
releasing a plant from a prepared plant assembly via the planting tool planting tube and into the formed hole, wherein the prepared plant assembly comprises
a plant; and
a plant protection guarding system, the guarding system comprising an upper sleeve, a lower portion comprising a plurality of anchor portions, the upper sleeve and the lower portion being formed from a single piece of material and a band;
wherein:
the upper sleeve is positioned around a plant stem and extends around the above ground portion of the plant;
the lower portion anchor portions extend around and connect together beneath the plant root ball; and
the band crimps together the base of the upper sleeve so as to reduce the diameter of the upper sleeve about the plant stem.
